(19) United States
(12) Patent Application Publication
(10) Pub. No.: US 2015/0336141 A1
(43) Pub. Date: Nov. 26, 2015

(54) Air Rinse System

(71) Applicant: Jet Air Technologies, LLC, Ventura, CA (US)

(72) Inventor: Michael Scott Lynn, Ventura, CA (US)

(21) Appl. No.: 14/717,909

(22) Filed: May 20, 2015

Related U.S. Application Data
(60) Provisional application No. 62/000,880, filed on May 20, 2014.

(51) Int. Cl. B08B 9/28; B08B 9/08; B08B 9/20

(52) U.S. Cl. CPC B08B 9/286; B08B 9/205; B08B 9/0826

(57) ABSTRACT

An air rinse method is disclosed that includes translating a container having an orifice past a plurality of nozzles, each of the plurality of the nozzles spaced apart approximately 2-12 inches on center and each of the plurality of nozzles directed in complementary opposition to the orifice and at an orifice entry angle (θ_{E}) of 0-40 degrees as the container translates over a respective nozzle, providing an ion air field, and directing pressurized air through the plurality of nozzles and through the ion air field so that pressurized and ionized air is directed through the orifice at the entry angle (θ_{E}) and into the container as the container translates over each of the plurality of nozzles.

### CROSS-REFERENCE TO RELATED APPLICATIONS

This application claims the benefit of U.S. Provisional Application No. 62/000,880 filed May 20, 2014, the disclosure of which is incorporated by reference herein for all purposes.

### BACKGROUND

1. Field of the Invention

The invention relates to bottle cleaning systems, and more particularly to air rinse systems for cleaning empty bottles.

2. Description of the Related Art

There are two typical types of air systems for removing particulate matter from manufactured, but not yet filled, bottles and cans prior to being filled with foods or beverages in the food and beverage industry: 1) compressed air systems that typically use 75 to 110 psi air at low volumes, and 2) blower air systems using 2 to 4 psi air at hundreds of cubic feet of air sourced from a blower. Compressed air systems are expensive to use and operate due to their utility energy costs and relatively expensive compressors. Blower air systems are significantly less expensive to operate, but thus far suffer from reduced cleaning performance verses their compressed air counterpart systems. A need continues to exist to provide an effective bottle and can cleaning system without requiring unnecessarily high utility energy and compressor costs.

### SUMMARY

An air rinse method includes translating a container having a container orifice past a plurality of nozzles, each adjacent nozzle of the plurality of the nozzles spaced apart approximately 2 to 12 inches on center and having an exit orifice inner diameter of ¼ inches to ½ inch, and directing pressurized air to the container orifice as the container translates over each one of the plurality of nozzles to create a periodic pressure buildup within an interior of the container. In some embodiments, the step of directing pressurized air to the container orifice also includes directing pressurized air to the container orifice at an orifice entry angle (θ_{E}) of 0 to 40 degrees from a centerline of the container as the container translates over each one of the plurality of nozzles. The method may also include providing an ion air field between the container orifice and each one of the plurality of nozzles so that the directed pressurized air passes through the ion air field. The container orifice may have a diameter of 10-80 mm, and the pressurized air may be pressurized at 35 IWG-150 IWG. The container may be translated past the plurality of nozzles at a rate of approximately 200-1600 nozzles per minute. In such embodiments, pressure buildup in the container is allowed to substantially exhaust as the container translates between adjacent nozzles of the plurality of nozzles. The method may also include providing a vacuum pull underneath a hat section that extends under the plurality of nozzles so that debris evacuated from the container falls past the hat section and is captured by the vacuum pull. The container volume may be approximately 100 ml to 2-liters.

An apparatus includes a nozzle header and a plurality of nozzles in pressure communication with the nozzle header, each of the plurality of nozzles spaced apart approximately 2 to 12 inches on center and each of the plurality of nozzles having an exit orifice inner diameter of ¼ inches to ½ inch. In some embodiments, an ion emission system may extend adjacent the plurality of nozzles, the ion emission system having a plurality of ion nozzles disposed adjacent the plurality of nozzles. An exterior surface of the nozzle header and the plurality of nozzles may include a non-metallic material. The apparatus may also include a container conveyer positioned in complementary opposition to the plurality of nozzles, and may include a plurality of containers detachably coupled to the container conveyer, a longitudinal axis (C_{LN}) of each of the plurality of nozzles angularly offset from an axial centerline (C_{L}) of each of the plurality of containers to establish container orifice entry angle (θ_{E}) of approximately 0 to 40 degrees.

Another apparatus may include a blower, a nozzle header in pressure communication with the blower, the nozzle header having a plurality of nozzles spaced apart 2 to 12 inches on center, a container conveyer positioned in complementary opposition to the plurality of nozzles, a plurality of containers detachably coupled to the container conveyer, each of the plurality of nozzles angularly offset from an axial centerline of the plurality of containers to establish an entry angle (θ_{E}) for pressurized air directed from the plurality of nozzles to the plurality of containers, when pressurized air is present, and an ion emission system extending adjacent the plurality of nozzles, the ion emission system having a plurality of ion nozzles disposed adjacent the plurality of nozzles. In some embodiments, an exterior surface of the nozzle header and the plurality of nozzles comprise a non-metallic material. Each of the plurality of nozzles may have an exit port having an inner diameter of ¼ inches to ½ inches. Each of the plurality of nozzles may have a nozzle length of approximately 1 to 6 inches. The container conveyer may be operable to translate containers at a rate of approximately 200-1600 containers per minute. In embodiments that use a nozzle header, an inner diameter cross sectional area of the nozzle header may be at least twice a collective cross sectional area of all of the exit ports of the plurality of nozzles.

### BRIEF DESCRIPTION OF THE DRAWINGS

The components in the figures are not necessarily to scale, emphasis instead being placed upon illustrating the principals of the invention. Like reference numerals designate corresponding parts throughout the different views;

FIGS. 1A and 1B are side plan and cross sectional views, respectively, of one embodiment of a system to air rinse containers such as bottles and cans;

FIGS. 2A, 2B and 2C are top plan and side views, respectively, of one embodiment of the air rinse box first illustrated in FIGS. 1A and 2B;

FIGS. 3A and 3B are top plan and side views, respectively, of a nozzle header having the plurality of nozzles illustrated in FIGS. 2A, 2B, and 2C;

FIG. 4 illustrates a system that is configured to direct pressurized air through an ionizing cloud and at an orifice entry angle (θ_{E}) of a container such as a bottle that is being translated over the nozzle;

FIGS. 5, 6, and 7 illustrate an interior of the rinse box first illustrated in FIG. 1 that has a debris collector to collect and remove debris evacuated from a bottle; and

FIG. 8 is a cross sectional view of the nozzle first illustrated in FIG. 2 that may guide pressurized air into a coherent stream for presentation through an ion field into a container orifice of a bottle.

### DETAILED DESCRIPTION

An air rinse system is described that includes the steps of translating a container past a plurality of nozzles, each of the plurality of nozzles oriented in complementary opposition to the container's orifice at an orifice entry angle (θ_{E}) of 0-40 degrees, to periodically direct pressurized and ionized air into the container as it passes over each respective nozzle while allowing soiled air and debris to escape the container as the container passes between adjacent nozzles. The inventive nozzle spacing, size and pressure, container orifice entry angle, system container velocity and use of ionize air facilitates effective debris removal without requiring unnecessarily high utility energy and compressor costs.

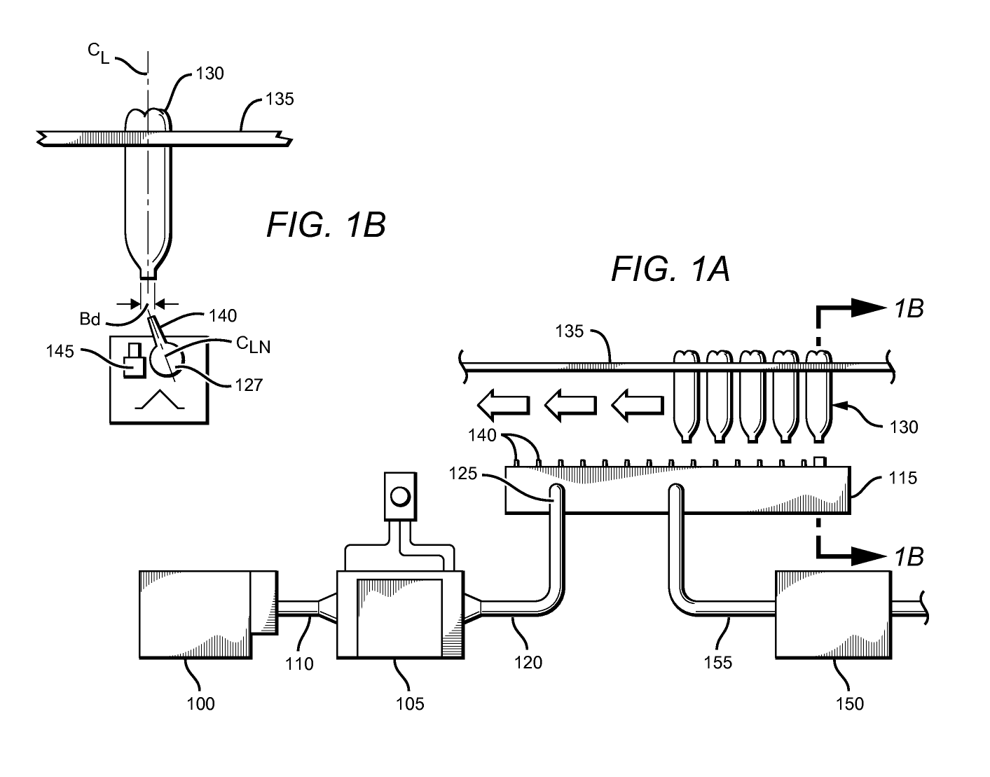

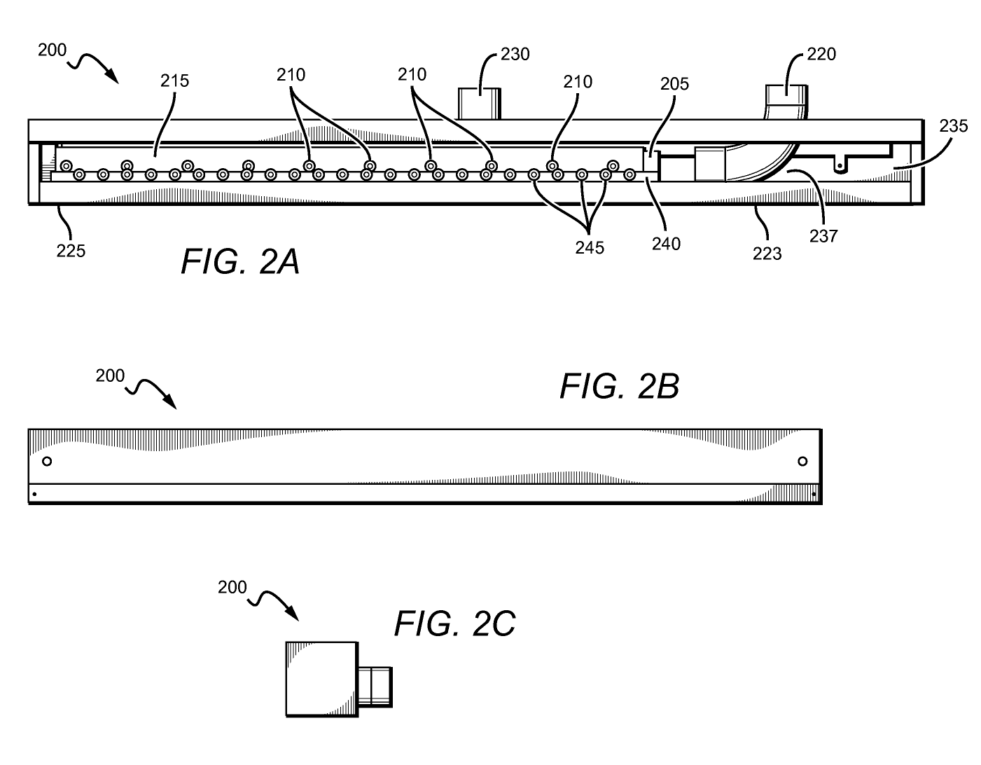

FIGS. 1A and 1B are side plan and cross sectional views, respectively, of one embodiment of a system to air rinse containers such as bottles and cans. The system may include a pressured air supplier such as a blower 100 that may introduce pressurized air into a HEPA filter enclosure 105 for filtering through a blower duct 110. In one embodiment, the air may be pressurized at the blower to approximately 35-150 IWG. The pressurized and filtered air may be fed to a rinse inlet 125 of a rinse box 115 through a blower inlet duct 120. A plurality of containers such as bottles or cans 130 may be detachably coupled to a container conveyer 135, with the container conveyer 135 operable to fixably orient and translate the bottles or cans 130 at a rate of approximately 200-1600 containers per minute (alternatively referred to as 200-1600 nozzles per minute) over a plurality of nozzles 140 that are in fluid communication with the rinse inlet 125 through a nozzle header 127. Each of the plurality of nozzles 140 may have a longitudinal axis (C_{LN}) that is angularly offset from an axial centerline (C_{L}) of each of the plurality of bottles or cans 130. Such a configuration establishes an orifice entry angle (θ_{E}) (see FIG. 7) for pressured air to create a pressure buildup in each bottle or can 130 as each bottle or can 130 passes over a respective nozzle 140. Each bottle or can 130 may have a container orifice inner diameter (Bd) of approximately 10-80 mm to accept the pressurized air. In one embodiment, an ionizing bar 145 may produce an ionizing field (see FIG. 4) adjacent each nozzle 140 through which the nozzle 140 directs the pressurized air for introduction into the plurality of bottles or cans 130. In this manner, each bottle or can 130 experiences a pressure buildup within its interior as it passes over a nozzle, with the pressure buildup substantially evacuating as the bottle or can 130 passes between nozzles 140. Any loose or loosened debris within the bottle or can 130 is induced to evacuate the bottle or can 130 with evacuation of the excess pressure between nozzles. A vacuum blower 150 may provide a vacuum pull to a debris catch area (see ref num. 235, FIGS. 2, 4, 7-10) that accepts debris dropped and collected from the containers for evaluation through an exhaust blower connection 155.

FIGS. 2A, 2B and 2C are top plan and side views, respectively, of one embodiment of the air rinse box first illustrated in FIGS. 1A and 2B, that includes a plurality of nozzles and an ionizing bar disposed adjacent to the nozzles and positioned to ionize pressurized air directed by the nozzles. The air rinse box 200 has a nozzle header 205 disposed within an interior of the box 200 that acts as a pressure vessel to supply a plurality of nozzles 210 with pressurized air. The nozzle header 205 and nozzles 210 may have an exterior surface or wrap 215 that is nonmetallic (and so non-conductive), such as PVC, ABS, or polyethylene. The nozzle header 205 may have a nozzle header inlet 220 at its proximal end 223 to receive pressurized air, and may be capped at its distal end 225. An exhaust duct 230 extends through a sidewall of the air rinse box 200 and into a rinse box interior 235 adjacent to a bottom portion 237 underneath a debris catch hat (see ref num. 500, FIGS. 8-10) to accept debris that may fall past the nozzle header 205 for evacuation of the debris out of the rinse system 200. An ionizing bar 240, such as a Keyence SJ-H Ionizing bar with integrated sensor offered by Keyence America of Itasca, Ill., may be positioned with its ion electrode probes 245 disposed adjacent the plurality of nozzles 210 to provide an ion field (alternatively referred to as a static elimination ion field) (see FIG. 7) through which pressurized air will pass. In an alternative embodiment, each nozzle 210 is provided with a respective adjacent ion electrode probe 245. Also, although the rinse box 200 is illustrated as generally rectangular in cross section, the phrase “box” is intended to encompass a partial enclosure that facilitates debris removal, such as semi-circular or curved trough, or that may function merely as a frame for supporting the associated nozzle header 205 and ionizing bar 240.

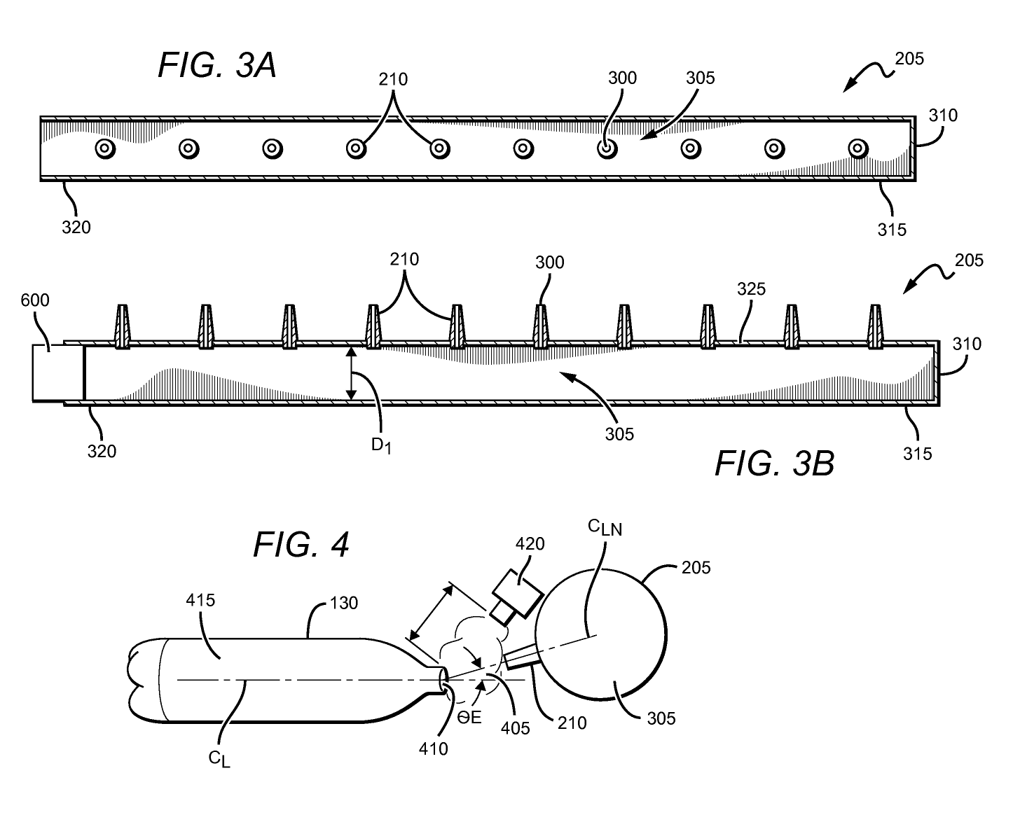

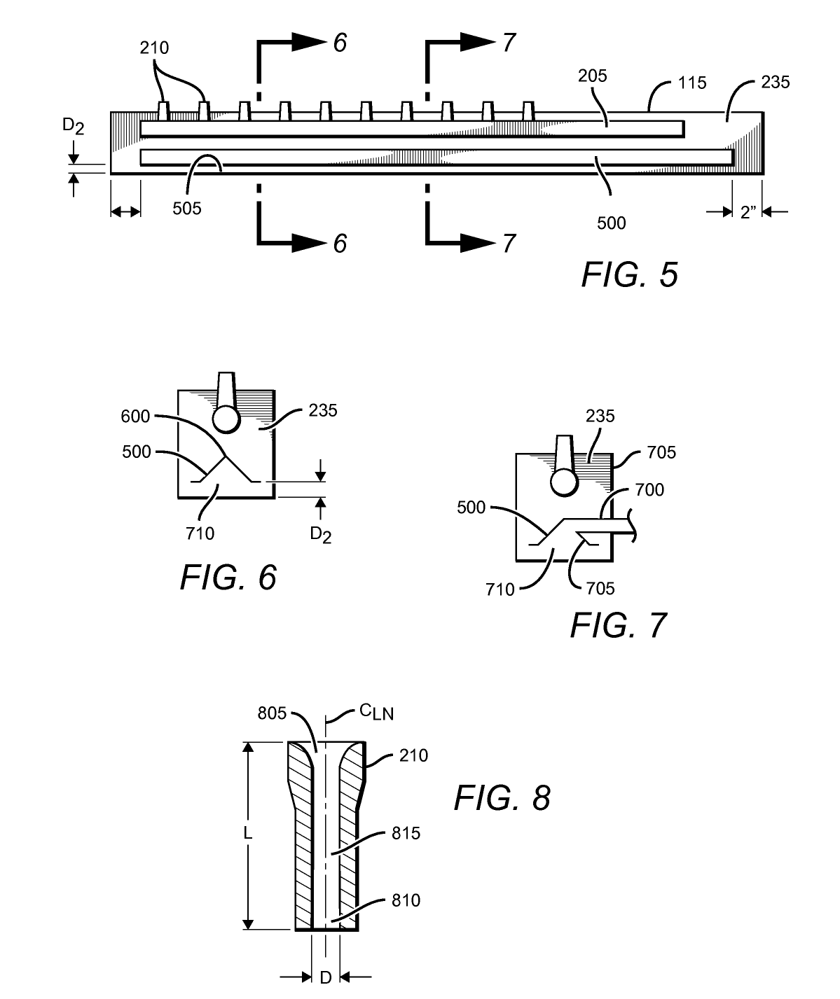

FIGS. 3A and 3B are top plan and side views, respectively, of a nozzle header having the plurality of nozzles illustrated in FIGS. 2A, 2B, and 2C. Each nozzle 210 may be formed on or coupled to the nozzle header 205, with an interior 300 of each nozzle 210 in fluid communication with an interior 305 of the nozzle header 205. Each nozzle 210 may be spaced apart from an adjacent nozzle by approximately 6 inches on center, may have a cylindrical cross section and a length of approximately 1 to 6 inches. In alternative embodiments, the nozzles may be spaced apart approximately 2 to 12 inches on center. The nozzle header 205 may have a cap 310 on a distal end 315 and may have a header inlet side 320 configured to receive a fluid inlet tube 600 for communication of pressurized air into an interior 305 of the nozzle header 205. The nozzle header 205 may have an inner diameter (ID) D₁ of approximately 2 to 6 inches. An ID cross sectional area of the nozzle header 205 may be at least twice a collective ID cross sectional area of all of the exit ports of the plurality of nozzles to maintain a desired pressure drop between and among the nozzles. An outer surface of the nozzles 210 and nozzle header may be wrapped or formed with a non-conductive material such as polyvinyl chloride (PVC), polyethylene, or acrylonitrile butadiene styrene (ABS) or other non-conducting and so non-grounded synthetic or semi-synthetic organic solid to reduce the potential for unintended attraction and grounding of ions generated by the ionizing bar (see FIG. 2). In an alternative embodiment, the nozzle header 205 is insulated from grounding and may be formed of any appropriate rigid or semi-rigid material. Although the nozzles 210 illustrated in FIGS. 5 and 6 are illustrated as extending perpendicularly from an outer surface 325 of the nozzle header 205, the nozzles 210 may extend from the outer surface 325 at a non-perpendicular angle, such as between 0 to 10 degrees from perpendicular, to facilitate nozzle direction of compressed air into each respective container orifice 410 (see FIG. 7) at the preferred orifice entry angle (θ_{E}).

FIG. 4 illustrates a system that is configured to direct pressurized air through an ionizing cloud and at an orifice entry angle (θ_{E}) of a container such as a bottle that is being translated over the nozzle to evacuate any debris previously existing within the bottle. The nozzle header 205 may be provided with pressurized air in its interior 305 for receipt by the nozzle 210. The nozzle 210 may guide the pressurized air into a coherent stream for presentation through an ion field 405 and into a container orifice 410 of the bottle 130 at an orifice entry angle (θ_{E}) of approximately 5 degrees from the bottle's longitudinal axis (L). In alternative embodiments, the orifice entry angle (θ_{E}) may be approximately 0 to 40 degrees. The ion field 405 may be generated by the ionizing bar 420 to provide pressurized and ionized air into an interior 415 of the bottle 130. The bottle may have a volume of up to approximately 2 liters in volume. In an alternative embodiment, the ionized air may be provided by other means, such as by pre-mixing upstream from the nozzle 210 or directly into an interior of the nozzle 210. Although illustrated in a horizontal position, the axial centerline (C_{L}) of the bottle 130 is preferably in a vertical or substantially vertical orientation and with the longitudinal axis (C_{LN}) of the nozzle 210 offset at the orifice entry angle (θ_{E}) from the axial centerline (C_{L}) of the bottle. In this manner, debris that may exist in the interior of the bottle is assisted by gravity in exiting the container orifice 410.

FIGS. 5, 6, and 7 illustrate an interior of the rinse box first illustrated in FIG. 1 that has a debris collector to collect and remove debris evacuated from a bottle. The nozzle header 205 may be seated or otherwise coupled to an interior of the rinse box 115, with the rinse box interior 235 otherwise referred to as a debris catch area. A debris collector hat section 500 may be disposed beneath the nozzle header 205 and spaced apart from a floor 505 of the debris catch area 235 by a hat floor spacing D₂ of approximately ¼ inches to ⅝ inches. The debris collector hat section 500 may have a triangular cross section with a peak 600 extending underneath and along the nozzle header 205 so that falling debris has a tendency to strike and bounce or otherwise slid off of the debris collector hat section 500 towards the floor 505 of the debris catch area 235 rather than accumulate on top of the hat section 500. An exhaust port 700 (FIG. 7) extends through a sidewall 705 of the debris collector hat section 500 and is in liquid communication with a vacuum pull to create a volume of relatively lower pressure 710 extending under the plurality of nozzles so that debris evacuated from the bottle falls past the hat section 500 and is captured by the vacuum pull for removal from the rinse box.

FIG. 8 is a cross sectional view of the nozzle first illustrated in FIG. 2 that may guide pressurized air into a coherent stream for presentation through an ion field into a container orifice of a bottle. The nozzle 210 may be a convergent nozzle having an ellipsoid nozzle inlet 805 and circular exit port 810, with the circular exit port having an exit orifice inner diameter of ¼ inches to ½ inches. Each nozzle 210 may also have a throttle section 815 of constant cross sectional area. The nozzle 210 may have a length to inner diameter ratio (L/D) of approximately eight, where the inner diameter is measured at the throttle section 815, to provide for improved coherent airflow output.

During operation, air may be generated by a blower 100 at a pressure ranging from 35-150 inches water column (IWG) and in sufficient flow to maintain that pressure through all of the nozzles (140/210). The air leaves the blower 100 and may pass through a HEPA filter 105 and before entering the rinse box (alternatively referred to as a “vacuum box”) 115. The air flows into the nozzle header (collectively 205, 237) of the vacuum box 115 and is distributed with minimal pressure drop through each of the nozzles (140/210). It exits the nozzle at an orifice entry angle (θ_{E}) about 5 degrees off of a center line C_{L} of a respective bottle that is travelling inverted above it. The inventive combination of bottle translation speed, nozzle spacing, and air pressure in view of container orifice size allows a blast of jet pressurized air to enter the bottle 130, build up pressure within the bottle and to substantially exhaust before the next adjacent nozzle is reached. That allows both time to stir up whatever debris that may exist in the bottle 130 and to let some of it evacuate between each nozzle (140/210).

At the end of the nozzle header 205, the box 115 extends for a distance to allow residual debris to fall out of the bottle 130 before leaving the cleaning area of interest. The debris falling out of the bottle is captured by the vacuum rinse box 115, and with the hat section 500 of the box 115 designed so that regardless of where the debris falls outside of the bottle 130, the debris will be captured and taken to an exhaust port 700. From the exhaust port 700, it may either be pulled out by a vacuum, a blower or an air amplifier 150. Preferably, a flow rate of about 400 cfm over 88 inches (about 50 cfm of exhaust air flow per inch) may be used. That creates an exhaust outflow of about twice the air inlet so as to keep debris from scattering outside the box 115. The hat section 500 is configured to maintain uniform airflow over the entire length in a compact space. Exhaust air can be taken to an exhaust system or dust-capture system. The goal of the air rinse system is to remove sufficient debris as to pass a customer's specific test for ionized rinsers, such as through the use of styrodots, debris based on size, or using a colorimeter test, each in accordance beverage industry standards. A variable frequency drive may also be used to adjust the blower pressure to optimize the amount of energy required to a minimum energy to meet the customer's standard.

The preferred embodiments of this invention have been illustrated and described above. Modifications and additional embodiments, however, will undoubtedly be apparent to those skilled in the art. Furthermore, equivalent elements may be substituted for those illustrated and described herein, parts or connections might be reversed or otherwise interchanged, and certain features of the invention may be utilized independently of other features. Consequently, the exemplary embodiments should be considered illustrative, rather than inclusive, while the appended claims are more indicative of the full scope of the invention.

What is claimed, is:

1. An air rinse method, comprising:
translating a container having a container orifice past a plurality of nozzles, each adjacent nozzle of the plurality of the nozzles spaced apart approximately 2 to 12 inches on center and having an exit orifice inner diameter of ¼ inches to ½ inch; and
directing pressurized air to the container orifice as the container translates over each one of the plurality of nozzles to create a periodic pressure buildup within an interior of the container.

2. The method of claim 1, wherein the directing pressurized air to the container orifice further comprises:
directing pressurized air to the container orifice at an orifice entry angle (θ_{E}) of approximately 0 to 40 degrees from a centerline of the container as the container translates over each one of the plurality of nozzles

3. The method of claim 1, further comprising:
providing an ion air field between the container orifice and each one of the plurality of nozzles so that the directed pressurized air passes through the ion air field.

4. The method of claim 1, wherein the container orifice has a diameter of 10-80 mm.

5. The method of claim 4, wherein the pressurized air is pressurized at 35 IWG-150 IWG.

6. The method of claim 5, wherein the container is translated past the plurality of nozzles at a rate of approximately 200-1600 nozzles per minute.

7. The method of claim 6, wherein pressure buildup in the container is allowed to substantially exhaust as the container translates between adjacent nozzles of the plurality of nozzles.

8. The method of claim 1, further comprising:
providing a vacuum pull underneath a hat section extending under the plurality of nozzles so that debris evacuated from the container falls past the hat section and is captured by the vacuum pull.

9. The method of claim 1, wherein the container volume is approximately 100 ml to 2-liters

10. An apparatus, comprising:
a nozzle header; and
a plurality of nozzles in pressure communication with the nozzle header, each of the plurality of nozzles spaced apart approximately 2 to 12 inches on center and having an exit orifice inner diameter of % inches to ½ inch.

11. The apparatus of claim 10, further comprising:
an ion emission system extending adjacent the plurality of nozzles, the ion emission system having a plurality of ion nozzles disposed adjacent the plurality of nozzles.

12. The apparatus of claim 11, wherein an exterior surface of the nozzle header and the plurality of nozzles comprise a non-metallic material.

13. The apparatus of claim 10, further comprising:
a container conveyer positioned in complementary opposition to the plurality of nozzles.

14. The apparatus of claim 13, further comprising:
a plurality of containers detachably coupled to the container conveyer, a longitudinal axis (C_{LN}) of each of the plurality of nozzles angularly offset from an axial centerline (C_{L}) of each of the plurality of containers to establish a container orifice entry angle (θ_{E}) of approximately 0 to 40 degrees

15. An apparatus, comprising:
a blower;
a nozzle header in pressure communication with the blower, the nozzle header having a plurality of nozzles spaced apart 2 to 12 inches on center;
a container conveyer positioned in complementary opposition to the plurality of nozzles;
a plurality of containers detachably coupled to the container conveyer, each of the plurality of nozzles angularly offset from an axial centerline of the plurality of containers to establish an entry angle (θ_{E}) for pressurized air directed from the plurality of nozzles to the plurality of containers, when pressurized air is present; and
an ion emission system extending adjacent the plurality of nozzles, the ion emission system having a plurality of ion nozzles disposed adjacent the plurality of nozzles.

16. The apparatus of claim 15, wherein an exterior surface of the nozzle header and the plurality of nozzles comprise a non-metallic material.

17. The apparatus of claim 15, wherein each of the plurality of nozzles has an exit port having an inner diameter of ¼ inches to ½ inches.

18. The apparatus of claim 15, wherein each of the plurality of nozzles has a nozzle length of approximately 1 to 6 inches.

19. The apparatus of claim 15, wherein the container conveyer is operable to translate containers at a rate of approximately 200-1600 containers per minute.

20. The apparatus of claim 15, wherein an inner diameter cross sectional area of the nozzle header is at least twice a collective cross sectional area of all of the exit ports of the plurality of nozzles.
